(19) United States
(12) Patent Application Publication
(10) Pub. No.: US 2007/0137389 A1
(43) Pub. Date: Jun. 21, 2007

(54) Bicycle grip shifter

(76) Inventor: Christopher A. Wickliffe, Ogden, UT (US)

Correspondence Address: MORRISS O''BRYANT COMPAGNI, P.C., 734 EAST 200 SOUTH, SALT LAKE CITY, UT, 84102, US

(21) Appl. No.: 11/528,853

(22) Filed: Sep. 27, 2006

Related U.S. Application Data
(60) Provisional application No. 60/721,185, filed on Sep. 27, 2005.

(51) Int. Cl. F16C 1/10

(52) U.S. Cl. 74/502.2

(57) ABSTRACT

Embodiments of the invention include grip shifters used on bicycles to control shifting of front and rear derailleurs. Embodiments of the grip shifters of the present invention are configured for sufficient shifter cable displacement for use with state-of-the-art linear front derailleurs disclosed in U.S. Pat. Nos. 6,454,671 and 7,025,698 to Wickliffe, the inventor of the present invention.

### CROSS-REFERENCE TO RELATED APPLICATIONS

This nonprovisional patent application claims benefit and priority under 35 U.S.C. § 119(e) of the filing of U.S. Provisional Patent Application Ser. No. 60/721,185 filed on Sep. 27, 2005, titled “BICYCLE GRIP SHIFTER”.

### BACKGROUND OF THE INVENTION

1. Field of the Invention

The present invention relates generally to bicycle gear shifting mechanisms. More particularly, this invention relates to bicycle grip shifters.

2. Description of Related Art

Bicycle gear shifting systems typically include an actuating assembly or shifter operatively connected by a control wire (often referred to as a “control cable” or simply “cable”) within a housing to a responding front or rear derailleur. Actuation of the shifter by a bicycle rider causes the derailleur to urge a bicycle chain between various sprockets of a cassette (also referred to as a “freewheel” or “cluster”) at the rear derailleur or chain rings at the front derailleur, thereby effecting a gear shift.

Conventional bicycle gear shifters can be located on brake levers, handlebars, stems or even the down tube of a bicycle. Among the handlebar mounted gear shifting mechanisms are lever-based shifters including: thumb activated, thumb and trigger (also known as “push-pull” or just “trigger”) shifters and bar-end shifters. The other handlebar mounted gear shifting mechanism is rotatable grip shifters (also known as “twistshifters”). Lever-based shifters are generally characterized by a pivoting motion during actuation. Grip shifters, on the other hand, are coaxially mounted about the handlebar ends and are characterized by a rotating motion substantially about the central axis of the handlebar.

Conventional lever-based shifters may be actuated by clasping the lever between the thumb and index finger and pivoting the lever forward or backward to pull or release the control cable. Thumb shifters, more conveniently mounted above the handlebar near the rider's hand, are actuated by using the thumb to nudge the pivoting lever forward or backward to the desired gear. Finally, “trigger” type shifters, likewise mounted near the rider's hand, but generally below the handlebar, comprise a pair of independent levers forming an acute angle about a common pivot point, one lever being pulled by the index finger to move the drive chain from a large to a smaller sprocket, the second lever being pushed by the thumb to move the chain from a small to a larger sprocket.

Bicycle riders generally have a given preference for desired placement of bicycle gear shifters. However, it is rare for a given bicycle component manufacturer to provide a wide selection of gear shifters and locations for bicycle component groups. Each type of gear shifting mechanism offers distinct methods of shift actuation for bicycle riders. Handlebar mounted shifters are generally preferable to down tube or stem mounted shifters, because the rider can control the gear shifting without removing hands from the handlebars to shift gears, which can create a potentially hazardous riding situation particularly in high performance bicycling, such as off-road mountain biking and racing. For this reason it is preferable for the bicycle rider to have a full grasp of the handlebars during shifting to maintain better control of the bicycle. But, one common problem with all lever-based shifters is the need for the rider to remove at least one finger from the handlebar grip during gear shifts.

Rotatable grip shifters eliminate this potential riding hazard by allowing the rider to maintain a full-fingered grip on the handlebar during all gear shifts. Grip shifters, which are generally located immediately inboard of the handlebar stationary grip, may be actuated by simply rotating the grip shifter surface about the handlebar to the desired gear shift position.

The gears of the bicycle may be selectively changed using gear shifters with control wires attached to front and rear derailleurs. Conventional gear shifters typically include a left-hand activated shifter for controlling derailment of the bicycle chain via a front derailleur among two or more chain rings of a bicycle crankset. Such conventional gear shifters also typically include a right-hand activated shifter for controlling derailment of the bicycle chain over five to ten rear cogs of a cluster or cassette gear mechanism.

Front and rear derailleurs are conventionally configured to accept a control cable, the displacement of which is used to selectively urge the bicycle chain to a selected gear cog (e.g., on a rear cassette or cluster) or chain ring (on a front crankset). Early gear shifters allowed generally smooth movement throughout the full range of the cable displacement. This required the bicycle rider to fine tune each gear shift to properly center the chain guiding mechanism of the front or rear derailleur over the intended gear cog. Today, most gear shifters utilize “indexed” or “ratcheted” gear selection mechanisms to automatically displace the chain guiding mechanism to a center point over the intended gear cog. This indexed shifting feature has become a welcome improvement over the unindexed shifting mechanisms which required more skill and attention to achieve a perfect shift of the gears.

It should be apparent from this discussion that these indexed gear shifting mechanisms have very standardized cable displacements and are generally designed to work with a particular derailleur. These standardized cable displacements are necessary for proper automatic indexed shifting. It should also be noted that all gear shifting mechanisms and their corresponding derailleurs have a generally standard maximum cable displacement that is selectively adjustable to prevent over-shifting past the last gear cog in a given direction.

Among the most recent developments in bicycle derailleurs is the so-called linear movement derailleur, which allows for more precise shifting. Exemplary state-of-the-art linear front derailleurs are disclosed in U.S. Pat. Nos. 6,454,671 and 7,025,698 to Wickliffe, the inventor of the present invention. However, to achieve the more precise shifting characteristics of these linear front derailleurs, greater cable displacement is required than is available in conventional gear shifters.

Lateral spacing between chain rings of a given crankset vary slightly from manufacturer to manufacturer and may also depend upon whether standard chain widths or narrow chain widths are being employed. For example, consider a conventional Shimano™ XTR™ FC-M952 triple crankset with 24, 34 and 46 teeth chain rings. The chain rings are laterally spaced from the next closest chain ring by about 0.3 inches. Thus, there is approximately 0.6 inches of lateral spacing between the smallest and largest chain ring in the Shimano™ XTR™ FC-M952 triple crankset when measured from center to center.

Similarly, the shifter cable displacement required to shift from one chain ring to the next and also the full cable displacement as measured during a shift from the smallest chain ring to the largest chain ring, will also vary based on the particular manufacturer, the front derailleur displacement mechanism (slant parallelogram, linear, etc.) employed and also whether a triple crankset or double crankset is being used. For example, using a conventional Shimano™ XTR™ FD-952 top pull front derailleur to shift the Shimano™ XTR™ FC-M952 triple crankset, a cable displacement of approximately 0.4 inches is required to shift from the 24 tooth chain ring to the 34 tooth chain ring, or vice versa. Similarly, a cable displacement of approximately 0.3 inches is required to shift from the 34 tooth middle chain ring to the 46 tooth big chain ring, or vice versa. Consequently, a full cable displacement to shift from the smallest chain ring to the largest chain ring, or vice versa, requires approximately 0.7 inches of cable displacement. These measurements correlate with those disclosed in U.S. Pat. No. 6,282,976 to Jordan et al. for a Shimano™ XTR™ bottom pull front derailleur, the contents of which are incorporated herein by reference for all purposes. More particularly, Jordan et al. shows in FIG. 7A that the full cable displacement is approximately 0.7 inches for a triple crankset.

In contrast, the linear front derailleurs disclosed in U.S. Pat. Nos. 6,454,671 and 7,025,698 to Wickliffe require a full cable displacement of approximately 1.2 inches, which cannot be achieved by any conventional bicycle gear shifter mechanism, because they are designed for conventional full cable displacements of only about 0.7 inches.

Exemplary conventional grip shifters may be found in U.S. Pat. Nos. 5,799,541, 5,823,058, 5,964,123 and 6,055,882 all to Arbeiter; U.S. Pat. No. 6,588,296 to Wessel and U.S. Pat. No. 6,282,976 to Jordan et al. However, none of these conventional twist grip shifters are configured to achieve the cable displacements necessary for the linear front derailleurs disclosed in U.S. Pat. Nos. 6,454,671 and 7,025,698 to Wickliffe.

Accordingly, there still exists a need in the art for a bicycle grip shifter that is capable of cable displacement necessary for state-of-the-art linear front derailleurs, thereby addressing at least one of the shortcomings of the prior art.

### BRIEF SUMMARY OF THE INVENTION

Embodiments of the invention include grip shifters used on bicycles to control shifting of front and rear derailleurs. Embodiments of the grip shifters of the present invention are configured for sufficient control cable displacement for use with state-of-the-art linear front derailleurs such as the linear front derailleurs disclosed in U.S. Pat. Nos. 6,454,671 and 7,025,698 to Wickliffe, the inventor of the present invention.

An embodiment of a bicycle grip shifter is disclosed. The bicycle grip shifter may include a grip shifter mount configured for placement around a handlebar. The bicycle grip shifter may further include a gear selection mechanism configured for rotational engagement around the grip shifter mount, the gear selection mechanism further comprising a universal ratchet gear configured for either front or rear shifter cable displacement. According to an embodiment of bicycle grip shifter, front shifter cable displacement exceeds about 0.5 inches per shift. A method of shifting a front derailleur as described above is also disclosed.

Additional features and advantages of the invention will be apparent from the detailed description which follows, taken in conjunction with the accompanying drawings, which together illustrate, by way of example, features of embodiments of the present invention.

### BRIEF DESCRIPTION OF THE SEVERAL VIEWS OF THE DRAWINGS

The following drawings illustrate exemplary embodiments for carrying out the invention. Like reference numerals refer to like parts in different views or embodiments of the present invention in the drawings.

FIGS. 1A and 1B are front and right-side views of an embodiment of a grip shifter body according to the present invention.

FIG. 2 is a flow chart of a method of shifting a front derailleur according to the present invention.

FIGS. 3A and 3B are front and bottom views of an embodiment of a grip shifter front housing according to the present invention.

FIGS. 4A and 4B are front and bottom views of an embodiment of a left grip shifter housing according to the present invention.

FIGS. 5A and 5B are front and bottom views of an embodiment of a right grip shifter housing according to the present invention.

FIG. 6 is a plan view of a universal ratchet gear for use with both right and left grip shifters according to an embodiment of the present invention.

FIGS. 7A and 7B are front and bottom views of an embodiment of a grip shifter mount according to the present invention.

FIGS. 8A and 8B are front and bottom views of an embodiment of a detent pin according to the present invention.

FIGS. 9A and 9B are right side and front views of an embodiment of a cable housing barrel according to the present invention

FIG. 9C is a side view of an embodiment of a cable housing barrel adjustment according to the present invention.

FIG. 10 is a drawing of a perspective view of an embodiment of an assembled grip shifter according to the present invention.

FIG. 11 is a drawing of a bottom angle perspective view of an embodiment of an assembled grip shifter according to the present invention.

FIG. 12 is a drawing of an end perspective view of an embodiment of an assembled grip shifter according to the present invention.

FIG. 13 is a drawing of a bottom perspective view of an embodiment of an assembled grip shifter according to the present invention.

FIG. 14 is a drawing of a perspective view of an embodiment of an annular grip and a grip shifter body with an elastically deformable cover according to the present invention.

### DETAILED DESCRIPTION OF THE INVENTION

Embodiments of the invention include grip shifters used on bicycles to control shifting of front and rear derailleurs. Embodiments of the grip shifters of the present invention are configured for sufficient control cable displacement for use with state-of-the-art linear front derailleurs disclosed in U.S. Pat. Nos. 6,454,671 and 7,025,698 to Wickliffe, the inventor of the present invention.

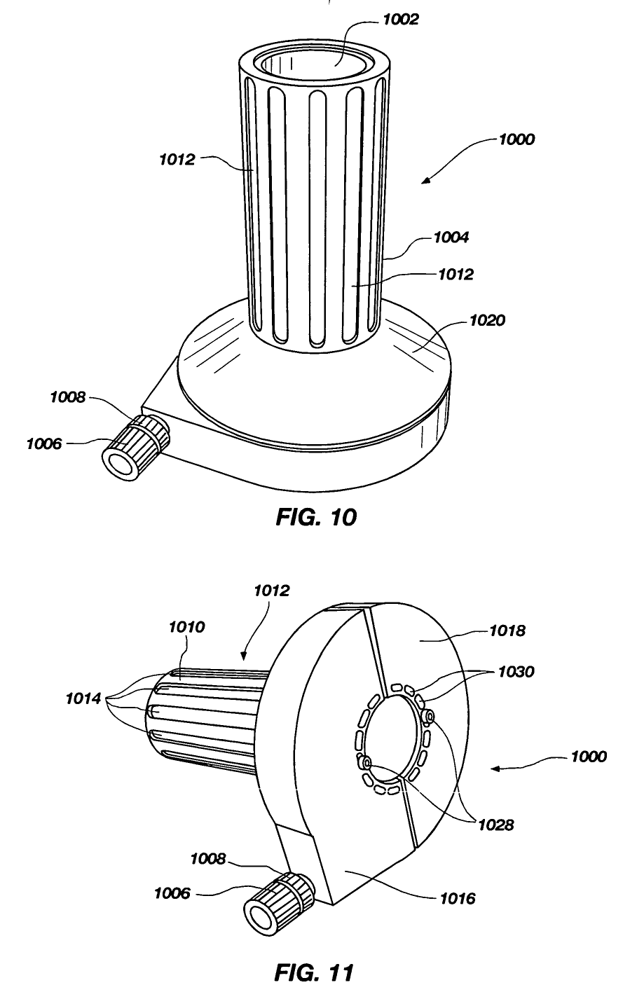

FIG. 10 is a drawing of a perspective view of an embodiment of an assembled grip shifter 1000 according to the present invention. Grip shifter 1000 may include a grip shifter mount 1002 configured for placement around a handlebar (not shown) and a gear selection mechanism 1004 configured for rotational engagement around the grip shifter mount 1002. FIG. 10 also illustrates a cable housing barrel 1006 and barrel adjustment ring 1008. The barrel adjustment ring 1008 allows for incremental adjustment of shifter cable tension to compensate for cable stretch or calibration of the shifting system. Gear selection mechanism 1004 may include a grip shifter body 1012. Grip shifter body may further include a shaft 1010 and flange 1020.

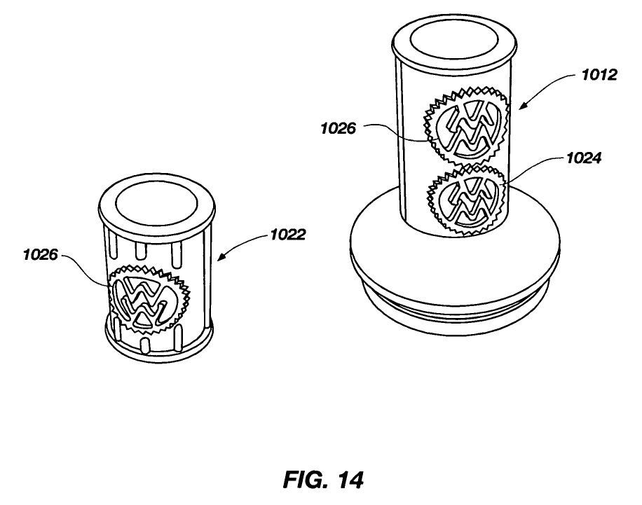

FIG. 11 is a drawing of a bottom angle perspective view of an embodiment of an assembled grip shifter 1000 according to the present invention. FIG. 11 illustrates another view of cable housing barrel 1006 and barrel adjustment ring 1008, both of which may be formed of aluminum or any other suitable material. FIG. 11 also shows that the gear selection mechanism 1004 may include a grip shifter body 1012 having a shaft 1010. The shaft 1010 may be fluted 1014 to receive an elastically deformable cover (not shown in FIG. 11 for clarity, but see 1024 in FIG. 14), wherein the inside of the elastically deformable cover has ribs configured to mate with the fluting 1014 of shaft 1010. The fluting 1014 of shaft 1010 and mating ribs are configured to prevent the elastically deformable cover from slipping around the grip shifter body 1012 when a rotational torque is applied to shift the grip shifter 1000.

FIG. 11 further illustrates a left grip shifter housing 1016 and mating grip shifter front housing 1018. Both the left grip shifter housing 1016 and the mating grip shifter front housing 1018 may be configured with mounting holes 1030 for selectively fixed engagement with grip shifter mount 1002. Screws 1028 (as shown in FIG. 11) may be used to secure the left grip shifter housing 1016 and the mating grip shifter front housing 1018 to the grip shifter mount 1002. However, other suitable means for fixedly engaging the housings 1016, 1018 to grip shifter mount 1002 may also be employed consistent with the present invention.

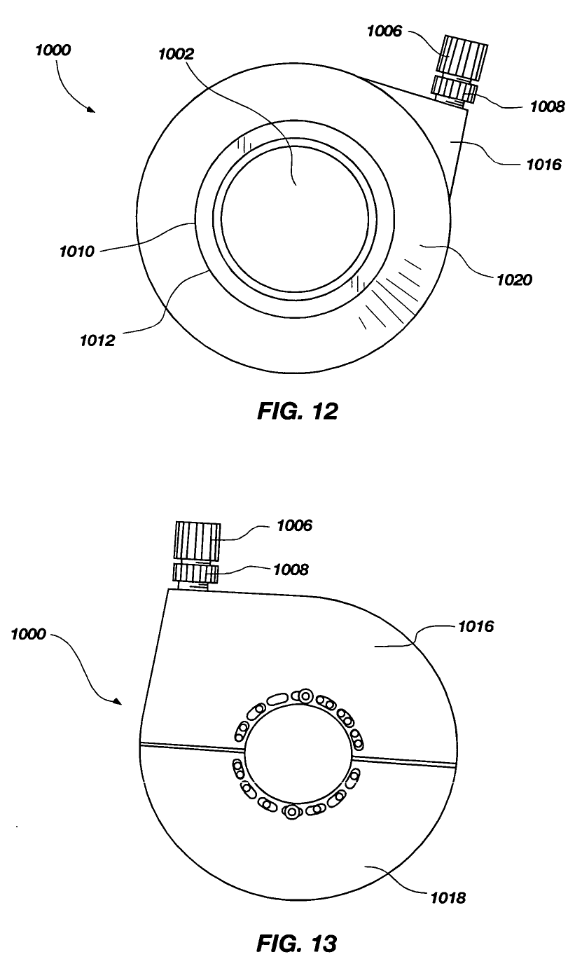

FIG. 12 is a drawing of an end perspective view of an embodiment of an assembled grip shifter 1000 according to the present invention. FIG. 12 illustrates grip shifter mount 1002 visible inside the shaft 1010 of grip shifter body 1012. FIG. 12 also illustrates a portion of left grip shifter housing 1016, supporting cable housing barrel 1006 and barrel adjustment ring 1008.

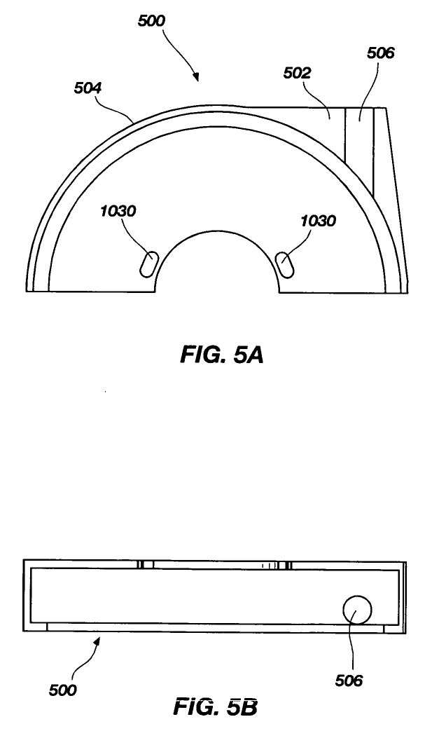

FIG. 13 is a drawing of a bottom perspective view of an embodiment of an assembled grip shifter 1000 according to the present invention. More particularly, FIG. 13 illustrates the mating of left grip shifter housing 1016 with grip shifter front housing 1018. FIG. 13 also shows another view of cable housing barrel 1006 and barrel adjustment ring 1008. The gear selection mechanism 1004 may include a grip shifter front housing 1018 and a right (not shown in the FIG. 13, but see 500 in FIGS. 5A and 5B) or left grip shifter housing 1016. The right grip shifter housing 500 (not shown in FIG. 13) is a mirror image of the left grip shifter housing 1016 and is further detailed with reference to FIGS. 5A and 5B, below. Both the left 1016 and right 500 grip shifter housings are configured to receive a cable housing barrel 1006 and are also configured to mate with the grip shifter front housing 1018. Both the left 1016 and right 500 grip shifter housings may also be configured with a plurality of mounting holes 1030.

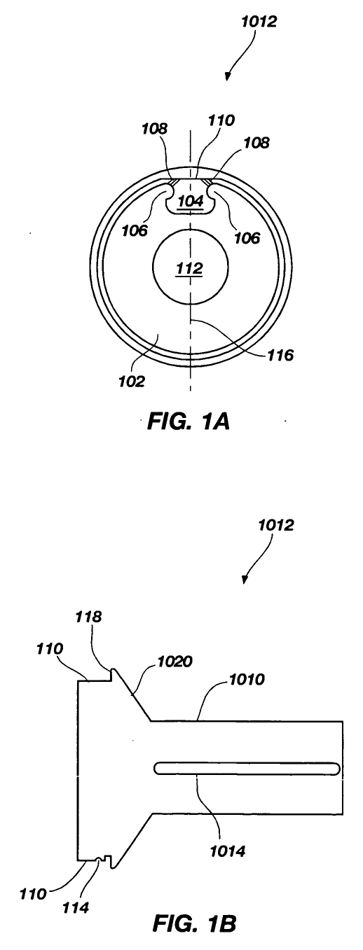

FIG. 14 is a drawing of a perspective view of an embodiment of an annular grip 1022 and a grip shifter body 1012 with an elastically deformable cover 1024 according to the present invention. The annular grip 1022 is configured for placement around a handlebar end (not shown in FIG. 14) adjacent the placement of grip shifter 1000. Annular grip 1022 is further configured not to slip around the handlebar once it is mounted thereon. Annular grip 1022 and elastically deformable cover 1024 are preferably patterned with designs 1026 to increase the friction for better holding of the grip shifter 1000 and handlebars during riding. Further details of the component parts of grip shifter 1000 will be discussed with reference to FIGS. 1-9, below.

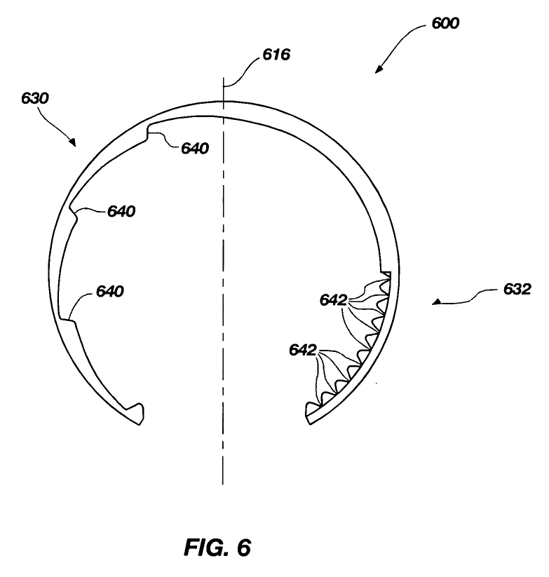

FIGS. 1A and 1B are front and right-side views, respectively, of an embodiment of a grip shifter body 1012 according to the present invention. Referring to FIG. 1A, grip shifter body 1012 may include a recess 102 for receiving a universal ratchet gear 600 (not shown in FIG. 1A, but see FIG. 6). The grip shifter body 1012 may further include a dual cable end holder 104. The dual cable end holder has two pockets 106 each having a cable tunnel 108 extending to an outer surface 110 of the grip shifter body 1012. Grip shifter body 1012 is configured with annular opening 112 passing through an axis of the grip shifter body 1012 and configured for receiving the grip shifter mount 1002 (not shown in FIG. 1A).

Referring now to FIG. 1B, the shaft 1010 and flange 1020 of the grip shifter body 1012 are shown. FIG. 1B also illustrates an exemplary flute 1014. Flutes 1014 (only one shown in FIG. 1B) may be selectively arranged around the shaft 1010. As noted above, the flutes 1014 may be configured to mate with ribs of an elastically deformable cover 1024 (recall FIG. 14) configured for placement over the grip shifter body 1012. FIG. 1B further illustrates a profile of a cable channel 114 set along the perimeter of the outer surface 110 of the grip shifter body 1012. Cable channel 114 provides a resting place for the shifter cable (not shown) to wrap around the outer surface 110 of the grip shifter body 1012. FIG. 1B also illustrates a lip 118 formed along the perimeter of outer surface 110 adjacent to flange 1020.

An embodiment of a bicycle grip shifter 1000 according to the present invention may include gear selection mechanism 1004 including a grip shifter body 1012 for receiving the universal ratchet gear 600 and a cable end block (not shown). The cable end block is configured to fit in one of the pockets 106 depending on whether the grip shifter 1000 is configured for front derailleur or rear derailleur gear selection. Referring again to FIG. 1A, because the grip shifter body 1012 is symmetrical about axis 116 (in dotted line), a cable (not shown) may be rotated in either direction around outer surface 110, depending on which pocket 106 is employed. Thus, grip shifter body 1012 may be configured for both front and rear gear selection. This is a particularly useful feature from a manufacturing perspective since a single grip shifter body 1012 may be used for either a right or left handed grip shifter for either front or rear gear selection.

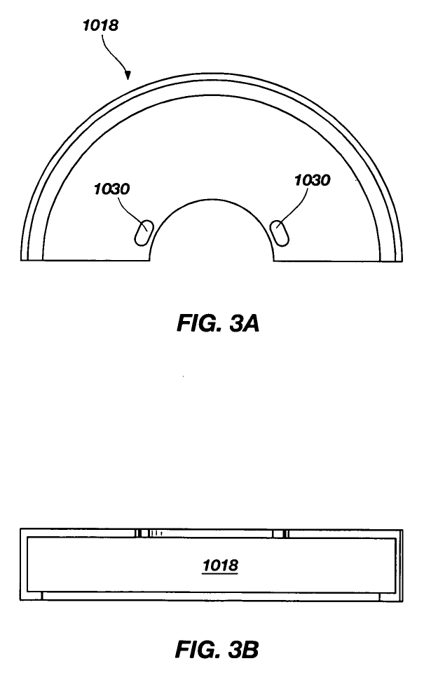

FIGS. 3A and 3B are front and bottom views of an embodiment of a grip shifter front housing 1018 according to the present invention. As noted above, grip shifter front housing 1018 is configured to mate with a left 1016 or right 500 grip shifter housing. As shown in FIG. 3A, grip shifter front housing 1018 may include a plurality of mounting holes 1030 (two shown in FIG. 3A) for securing grip shifter front housing 1018 to grip shifter mount 1002. Referring to FIG. 3B, grip shifter front housing 1018 may be generally hollow and semi-circular in shape. Grip shifter front housing 1018 may be formed of aluminum or steel or any other suitable material according to embodiments of the present invention.

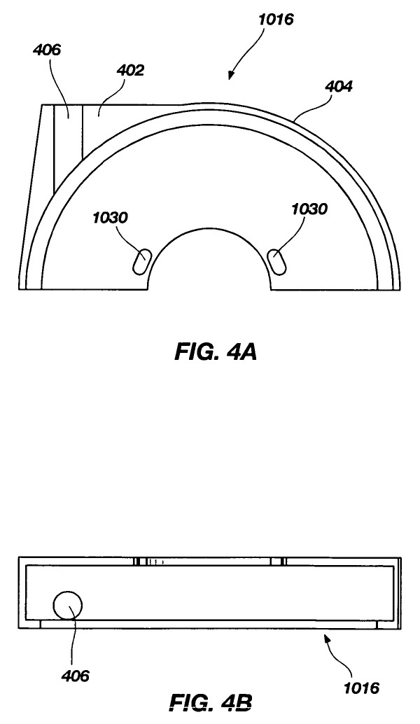

FIGS. 4A and 4B are front and bottom views of an embodiment of a left grip shifter housing 1016 according to the present invention. Left grip shifter housing 1016 is also generally hollow and semi-circular in shape. However, left grip shifter housing 1016 also includes a support structure 402 extending from semi-circular body 404. Support structure 402 also includes a cable housing hole 406 for receiving the cable housing barrel 1006 and barrel adjustment ring 1008.

FIGS. 5A and 5B are front and bottom views of an embodiment of a right grip shifter housing 500 according to the present invention. As noted above, right grip shifter housing 500 is a mirror image of left grip shifter housing 1016. Right grip shifter housing 500 also has a generally hollow and semi-circular shape, including a support structure 502 extending from semi-circular body 504. Support structure 502 also includes a cable housing hole 506 for receiving the cable housing barrel 1006 and barrel adjustment ring 1008.

Referring to FIG. 6, the gear selection mechanism 1004 may further include a universal ratchet gear 600 configured for either front or rear shifter cable displacement. FIG. 6 is a plan view of a universal ratchet gear 600 for use with both right and left grip shifters 1000 according to an embodiment of the present invention. Universal ratchet gear 600 is configured to fit in recess 102 of grip shifter body 1012, according to one embodiment. Universal ratchet gear 600 may be configured to fit adjacent lip 118 of grip shifter body according to another embodiment. Universal ratchet gear 600 is “C” shaped and may be defined in part by an axis 616. Along the left hemisphere, shown generally at arrow 630 (on the left side of axis 616) of the universal ratchet gear 600 are three chain ring notches 640 that receive a detent pin (see 800 in FIGS. 8A and 8B) that define rotational positions of the grip shifter 1000 (typically a left-handed shifter for the front gears) corresponding to the three chain rings of a triple crankset (not shown). Along the right hemisphere, shown generally at arrow 632 (on the right side of axis 616) of the universal ratchet gear are nine cassette notches 642 that receive a detent pin 800 (as shown and further discussed with regard to FIGS. 8A-B, below) that define rotational positions of the grip shifter 1000 (typically a right-handed shifter for the rear gears) corresponding to nine cogs of a cassette or freewheel (not shown). Of course, it will be evident that a double crankset may be accommodated by two appropriately spaced chain ring notches 640 formed in the left hemisphere 630 of universal ratchet gear 600. Similarly, any number of rear cogs (e.g., 5-10) may be accommodated by selecting the appropriate number of appropriately placed cassette notches 642 along the right hemisphere 632.

The bicycle grip shifter 1000 cable displacement may be measured by the distance along an arc on the outer surface 110 of the grip shifter body 1012 as defined by the placement of notches 640 and 642. According to one embodiment of grip shifter 1000, front shifter cable displacement exceeds about 0.5 inches per shift. Thus, according to that embodiment, a shift from one chain ring notch 640 to the next adjacent chain ring notch 640 corresponds to more than about 0.5 inches of front shifter cable displacement. According to another embodiment of grip shifter 1000, full front shifter cable displacement ranges from about 1.1 inches to about 1.3 inches. According to a presently preferred embodiment of grip shifter 1000, full front shifter cable displacement is about 1.2 inches.

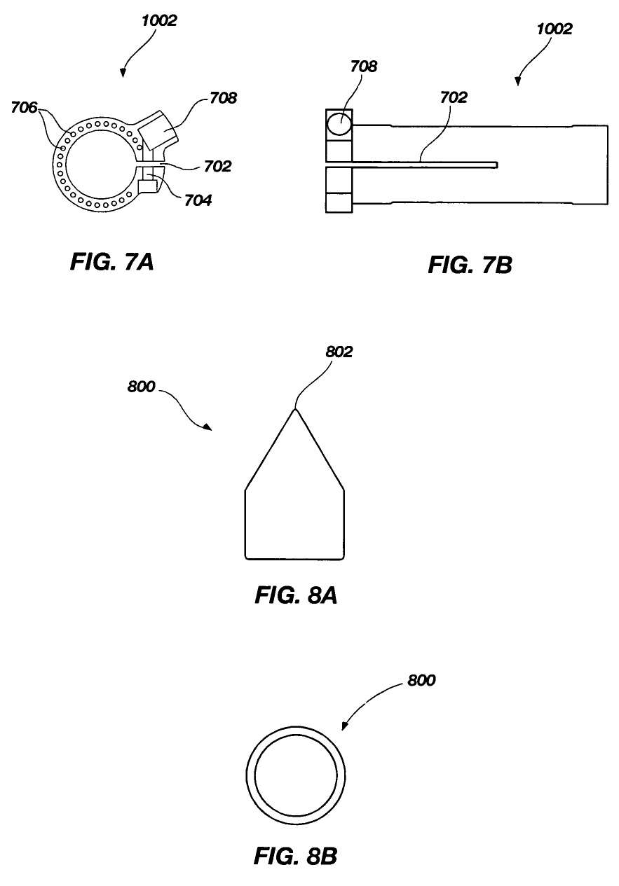

FIGS. 7A and 7B are front and bottom views of an embodiment of a grip shifter mount 1002 according to the present invention. According to one embodiment of bicycle grip shifter 1000, the grip shifter mount 1002 may be configured to be secured to the handlebar (not shown). For example, grip shifter mount 1002 may have a gap 702 configured to be at least partially closed around the handlebar (not shown) by a bolt (not shown) threaded in to mounting hole 704. Grip shifter mount 1002 may further be configured with a plurality of adjustment holes 706 (a plurality of which are shown in FIG. 7A) for mating with mounting holes 1030 in left and right grip shifter housings 1016 and 500, respectively and grip shifter front housing 1018. Grip shifter mount 1002 may further be configured with a detent pin receptacle 708. According to an embodiment of bicycle grip shifter 1000, the grip shifter mount may be configured for receiving a detent pin 800 (see FIGS. 8A-B) for engaging the universal ratchet gear 600.

FIGS. 8A and 8B are front and bottom views of an embodiment of a detent pin 800 according to the present invention. Detent pin may be configured with a spring (not shown) to press the point 802 into notches 640 or 642. Detent pin 600 may be formed of any suitable hard material, e.g., steel.

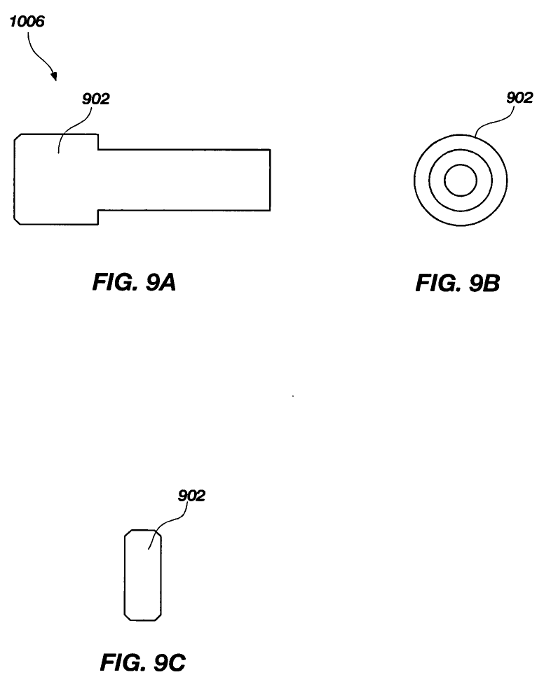

FIGS. 9A and 9B are right side and front views of an embodiment of a cable housing barrel 1006 according to the present invention. Cable housing barrel 1006 may include a head that is knurled for ease of gripping and rotating, according to an embodiment of the present invention. FIG. 9C is a side view of an embodiment of a barrel adjustment ring 1008 according to the present invention. The outer surface 904 of the barrel adjustment ring 1008 may also be knurled for ease of gripping and rotating.

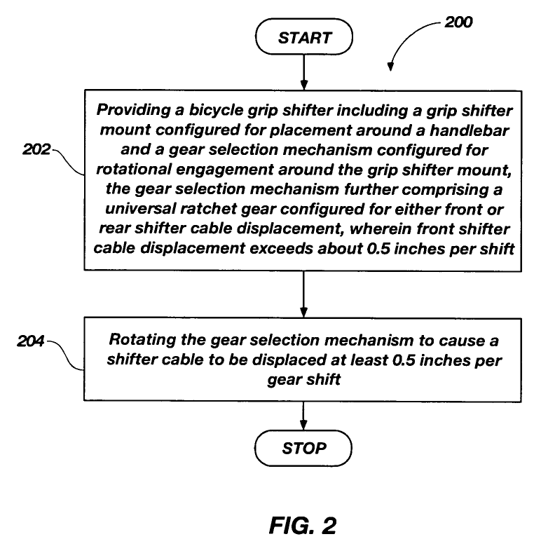

FIG. 2 is a flow chart of a method 200 of shifting a front derailleur according to the present invention. Method 200 may include, comprising:

providing a bicycle grip shifter, comprising:

a grip shifter mount configured for placement around a handlebar; and

a gear selection mechanism configured for rotational engagement around the grip shifter mount, the gear selection mechanism further comprising a universal ratchet gear configured for either front or rear shifter cable displacement, wherein front shifter cable displacement exceeds about 0.5 inches per shift; and

rotating the gear selection mechanism to cause a shifter cable to be displaced at least 0.5 inches per gear shift.

While the foregoing advantages of the present invention are manifested in the illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A bicycle grip shifter, comprising:
a grip shifter mount configured for placement around a handlebar; and
a gear selection mechanism configured for rotational engagement around the grip shifter mount, the gear selection mechanism further comprising a universal ratchet gear configured for either front or rear shifter cable displacement.

2. The bicycle grip shifter according to claim 1, wherein front shifter cable displacement exceeds about 0.5 inches per shift.

3. The bicycle grip shifter according to claim 1, wherein the grip shifter mount is further configured to be secured to the handlebar.

4. The bicycle grip shifter according to claim 1, wherein the grip shifter mount is further configured for receiving a detent pin for engaging the universal ratchet gear.

5. The bicycle grip shifter according to claim 1, wherein the gear selection mechanism further comprises a grip shifter body for receiving the universal ratchet gear and a cable end.

6. The bicycle grip shifter according to claim 5, wherein the grip shifter body is configured for both front and rear gear selection.

7. The bicycle grip shifter according to claim 5, wherein the grip shifter body is configured for receiving a shifter cable end block.

8. The bicycle grip shifter according to claim 5, further comprising an elastically deformable cover configured for placement over the grip shifter body.

9. The bicycle grip shifter according to claim 1, further comprising an annular grip comprising an elastically deformable material configured for fixed placement adjacent to the bicycle grip shifter on the handlebar.

10. The bicycle grip shifter according to claim 1, wherein the gear selection mechanism further comprises:
a grip shifter front housing; and
a right or left grip shifter housing, wherein both the left and the right grip shifter housing are configured to receive a cable housing barrel and also configured to mate with the grip shifter front housing.

11. The bicycle grip shifter according to claim 1, wherein full front shifter cable displacement ranges from about 1.1 inches to about 1.3 inches.

12. The bicycle grip shifter according to claim 11, wherein the full front shifter cable displacement is about 1.2 inches.

13. A method of shifting a front derailleur, comprising:
providing a bicycle grip shifter, comprising:
a grip shifter mount configured for placement around a handlebar; and
a gear selection mechanism configured for rotational engagement around the grip shifter mount, the gear selection mechanism further comprising a universal ratchet gear configured for either front or rear shifter cable displacement, wherein front shifter cable displacement exceeds about 0.5 inches per shift; and
rotating the gear selection mechanism to cause a shifter cable to be displaced at least 0.5 inches per gear shift.
